(19) United States
(12) Patent Application Publication
(10) Pub. No.: US 2009/0327289 A1
(43) Pub. Date: Dec. 31, 2009

(54) METHODS AND SYSTEMS FOR MANAGING SIMILAR AND DISSIMILAR ENTITIES

(76) Inventor: Michael G. Zentner, West Lafayette, IN (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/553,518

(22) Filed: Sep. 3, 2009

Related U.S. Application Data
(63) Continuation of application No. 11/537,150, filed on Sep. 29, 2006, now abandoned.

(51) Int. Cl. G06F 17/30

(52) U.S. Cl. 707/6; 707/E17.039

(57) ABSTRACT

Search criteria and potential targets of searches are each represented by a classification of attributes. The search classifications and target classifications are compared to determine whether a target matches or loosely matches the search criteria. The search classifications and target classifications may be modified to increase the chance of a match or loose match. A user can request to modify a classification using a visual interface in which information about the classification is presented. The matching approach may be implemented in conjunction with conventional matching methods to provide classifications. The matching approach is capable of interacting with users of the approach to dynamically alter the classifications being searched based on any given set of search results.

### RELATED APPLICATION DATA

The present application is a continuation of U.S. patent application Ser. No. 11/537,150, filed Sep. 26, 2006, which is fully incorporated herein in its entirety to the extent permitted by law.

### FIELD OF THE INVENTION

The present invention relates to computerized searching and information analysis, and in particular, the invention relates to computerized searching and information analysis using classification frameworks.

### BACKGROUND OF THE INVENTION

For a variety of reasons, people and computer software agents (searchers) routinely engage in search activities to locate entities (targets) in which they are interested, but the existence and location of which they are uncertain. For example, i) corporate strategy group searchers routinely search for other target corporations or technologies which are complementary for either acquisition or partnerships, ii) computer user searchers routinely engage in World Wide Web based searches for target digital information, iii) consumer searchers search for target suppliers through a variety of mechanisms including business directories, the World Wide Web, and others, and so forth. Existing search methods are limited by the accuracy of the search results, reliance upon standards that are not global, and by their lack of transportability.

### SUMMARY OF THE INVENTION

Methods, systems, and articles of manufacture consistent with the present invention allow a searcher to find a target for which they are searching faster and more accurately than possible with conventional approaches. Conceptual representations of targets and searches are provided that can be analyzed algorithmically to provide matches and allow navigation. A classification framework (CF) allows targets to be classified by one or more classifications for multiple purposes by multiple searchers. The CF is based on a variety of features of the target including, but not limited to, textual information.

In addition to classifying targets, functionality is provided for defining searches. For example, a user may define a search CF incrementally. CFs may be compared for similarities and complementarities in the absence of a global standard for CF expression (i.e., CF analysis). The results of a CF analysis may be provided to searchers and targets as guidance for modifying their CFs for better refinement of search results. Searchers may also navigate by the structure of CFs to find and analyze related entities to those classified by CFs. Further, searchers may rapidly visualize the analytic characterization by CFs of large sets of targets, and interact with this visualization to partition targets into relevant and irrelevant sets based on the searcher's criteria. The CF may be used in conjunction with existing search methods for better refinement of those search methods and establishment of CFs for the results returned by those search methods. Searchers may also share their CFs with other searchers and targets. Creators and users of various CFs are automatically notified when the content matched by those CFs changes. Searchers and targets may define CF “templates,” which will allow for the translation of a CF into an alternate CF.

In accordance with methods consistent with the present invention, a method in a data processing system having a computer program for locating an item is provided. The method comprises the steps of: obtaining at least one search parameter for locating the item; classifying the at least one search parameter into a search classification; and comparing the search classification to at least one target search classification associated with a target item to determine whether the target item matches or loosely matches the item.

In accordance with articles of manufacture consistent with the present invention, a computer-readable medium having instructions that cause a data processing system to perform a method for locating an item is provided. The method comprises the steps of: obtaining at least one search parameter for locating the item; classifying the at least one search parameter into a search classification; and comparing the search classification to at least one target search classification associated with a target item to determine whether the target item matches or loosely matches the item.

In accordance with systems consistent with the present invention, a data processing system is provided. The data processing system has a memory having a computer program for locating an item that obtains at least one search parameter for locating the item, classifies the at least one search parameter into a search classification, and compares the search classification to at least one target search classification associated with a target item to determine whether the target item matches or loosely matches the item. A processing unit runs the computer program.

In accordance with systems consistent with the present invention, a data processing system is provided. The data processing system comprises: means for obtaining at least one search parameter for locating the item; means for classifying the at least one search parameter into a search classification; and means for comparing the search classification to at least one target search classification associated with a target item to determine whether the target item matches or loosely matches the item.

The above-mentioned and other features, utilities, and advantages of the invention will become apparent from the following detailed description of the preferred embodiments of the invention together with the accompanying drawings.

Other systems, methods, features, and advantages of the invention will become apparent to one with skill in the art upon examination of the following figures and detailed description. It is intended that all such additional systems, methods, features, and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention.

FIG. 1 is a block diagram of a system suitable for use with methods and systems consistent with the present invention.

FIG. 2 is a block diagram of a data processing system shown in more detail.

FIG. 3 is a block diagram depicting an entity classified by CF Instantiations.

FIG. 4 depicts a hierarchy of an illustrative CF Instantiation.

FIG. 5 is a block diagram of an illustrative CF Instantiation Library.

FIG. 6 illustrates a block diagram of an illustrative CF Dictionary.

FIG. 7 is a flow diagram depicting illustrative steps performed by the program for defining a CF.

FIG. 8 depicts a flow diagram showing illustrative steps performed by the program for approving a CF Node.

FIG. 9 shows illustrative CF Nodes marked in complementary zones or similarity zones.

FIG. 10 is a flow diagram showing illustrative steps performed by the program to perform Content Matching.

FIG. 11 is a flow diagram showing illustrative steps performed by the program to perform Relationship Matching.

FIG. 12 is a flow diagram showing illustrative steps performed by the program to perform Path Matching.

FIG. 13 depicts an illustrative Target CF Instantiation.

FIG. 14 depicts a plurality of Searcher CF Instantiations.

FIG. 15 shows an illustrative CF Match Library.

FIG. 16 shows an illustrative CF Match Dictionary.

FIG. 17 depicts an illustrative CF Search Dictionary.

FIG. 18 depicts another illustrative CF Search Dictionary.

FIG. 19 is a flow diagram showing illustrative steps performed by the program for modifying a CF responsive to a user input.

FIG. 20 depicts illustrative CF Instantiations.

FIG. 21 shows an illustrative CF Transformation Lens.

FIG. 22 shows illustrative CF Instantiations resulting from using a CF Transformation Lens.

FIG. 23 is a flow diagram depicting illustrative steps performed by the program for integrating a search with a conventional search method.

FIG. 24 is a flow diagram depicting illustrative steps performed by the program for communicating the results to a Searcher.

### DETAILED DESCRIPTION OF THE PRESENTLY PREFERRED EMBODIMENTS

Reference will now be made in detail to an implementation consistent with the present invention as illustrated in the accompanying drawings. Wherever possible, the same reference numbers will be used throughout the drawings and the following description to refer to the same or like parts.

Methods, systems, and articles of manufacture consistent with the present invention allow a searcher to find a target for which they are searching faster and more accurately than possible with conventional approaches. Targets and searches are classified by classification frameworks (CF) that represent features of the targets and searches. These CFs can be analyzed algorithmically to provide matches and allow navigation. A CF allows targets to be classified by one or more classifications for multiple purposes by multiple searchers. CFs of targets and searches may be compared for similarities and complementarities and modified to achieve improved search results.

Methods, systems, and articles of manufacture consistent with the present invention may have a variety of applications. For example, they may be used to search and analyze customers' voices, searching for documentation, integrating information across disparately structured data processing systems, cataloging and analyzing customer surveys, extracting market competitive trends from library searches, news feeds, and World Wide Web information sources, and other applications.

In an illustrative example, a user may want to locate information relating to a particular bicycle by searching web pages on the Internet. The user inputs information about the desired bicycle, and as described in more detail below, a computer program builds a CF for the user. The computer program then compares the user CF relating to the bicycle to CFs of potential matches to determine whether a matching bicycle can be found or at least a loose match. Based on the search results, the user can instruct the program to modify the user's CF to increase the chance of obtaining a match. Further, the CFs for potential matches may be modified to improve their chances of providing a match to searches based on the bicycle's CF.

The following terminology serves as a set of illustrative classifications useful for describing methods, systems, and articles of manufacture consistent with the present invention. The illustrative terminology does not limit the claimed invention to the scope of this terminology, which is used for purposes of illustration and not limitation.
1) Classification Framework (CF)—A CF is a way of describing an Entity conceptually. Such descriptions may include, but not be limited to, the functionality performed by an Entity, its method of manufacture, its physical attributes, its relationships to other entities, its geographic location, its ownership, textual, audible and visual descriptions, and so forth.
2) CF Analysis—CF Analysis refers to the process of comparing multiple CF Instantiations, which are described below. Comparisons may be based upon, but not limited to, any of the following illustrative examples: similarities between two CF Instantiations, discrepancies between two CF Instantiations, complementarities between two CF Instantiations, aggregate similarities and statistical properties of a group of CF Instantiations, aggregate discrepancies and statistical properties between multiple groups of CF Instantiations, and aggregate complementarities between multiple groups of CF Instantiations and their statistical properties.
3) CF Dictionary—The CF Dictionary is the set of unique CF Nodes, independent of attribution, in the CF Instantiation Library as defined by the CF Node Unique Identifier, and the set of relationships between unique CF Nodes present in the CF Instantiation Library.
4) CF Instantiation—A CF Instantiation represents a specific instance of applying the CF to an Entity. By way of example and not limitation, the CF describing the city of Chicago, a bicycle, the content of the Mona Lisa, or a printing press would be a CF Instantiation.
5) CF Search Instantiation—A CF Search Instantiation is a CF Instantiation which is not applied to a particular Entity, but instead serves as a pattern that may be matched against CF Instantiations to locate Entities.
6) CF Instantiation Library (CFIL)—The set of known CF Instantiations.
7) CF Node—A CF Node is a basic element within a CF Instantiation.
8) CF Arc—A CF Arc connects two CF Nodes together. Arcs allow CF Nodes to be arranged in a hierarchical fashion. A CF Arc is defined by the CFNUIDs of the CF Nodes it connects, and by the CF Node Labels and CF Node Attributions it connects. CF Node Attributions are described below. The CF Arc is a “directed” connection. One CF Node in the connection is a “parent” and the other is a “child.” Therefore, for two CF Nodes, A and B, if there are two directed connections one with A as the parent and B as the child, and the other with A as the child and B as the parent, the two CF Arcs defined by those connections are distinct.
9) CF Path—A CF Path is the collection of CF Nodes and CF Arcs present between two CF Nodes. If some sequence of CF Arcs can be followed, regardless of direction, between the CF Nodes A and B, the sequence of CF Nodes and CF Arcs encountered along the traversal is the CF Path between A and B. When all CF Arcs follow the same direction, the CF Path is a CF Directed Path.
10) CF Path Constraint—a CF Path Constraint is a definition of a property relative to a path. A CF Path meets a CF Path Constraint if the structure of the CF Path satisfies all criteria of the constraint. Such criteria may include but not be limited to all CF arcs in the CF Path following a specific direction, a range or number specifying the total number of CF Arcs contained in the CF Path, a specific sequence of CF Arc directions, or specific counts or ranges of CF Arcs which are in specific directions.
11) Valid CF Path—a Valid CF Path is a CF Path which satisfies a specific CF Path Constraint. The Valid CF Path is only valid with respect to the CF Path Constraint that it satisfies.
12) CF Creation Path—In an illustrative example, when a new CF “B” is created using an existing CF “A” as a starting point, the CF Creation Path of “B” is “A→”. In a similar fashion, the CF “B” may serve as the basis for creating CF “C”. The CF Creation Path for CF “C” is “A→B→C”.
13) CF Node Type—CF Nodes are categorized by CF Node Types. Examples of CF Node Types may include but are not limited to: function, location, process, weight, textual, audible, and visual descriptions and so forth.
14) CF Node Label—CF Nodes may be labeled with a CF Node Label. Examples of CF Node Labels may include but are not limited to: color, locomotion, radiation, and so forth.
15) CF Node Attribution—CF Nodes may contain zero or more attributions. Examples may include but not be limited to: red, 50 lb, $8.75, and so forth.
16) CF Node Unique Identifier (CFNUID)—A unique identifier for a CF node, independent of its CF Node Attribution and CF Node Label.
17) Entity—An Entity is either a Searcher or Target.
18) Searcher—A Searcher is a party that is seeking to find an Entity. By way of example and not limitation, a Searcher may be a corporation, a person, a computer program, and the like.
19) Target—A Target is a party that seeks to be found by Searchers. By way of example and not limitation, a Target may be a corporation, a person, a computer program, and the like.

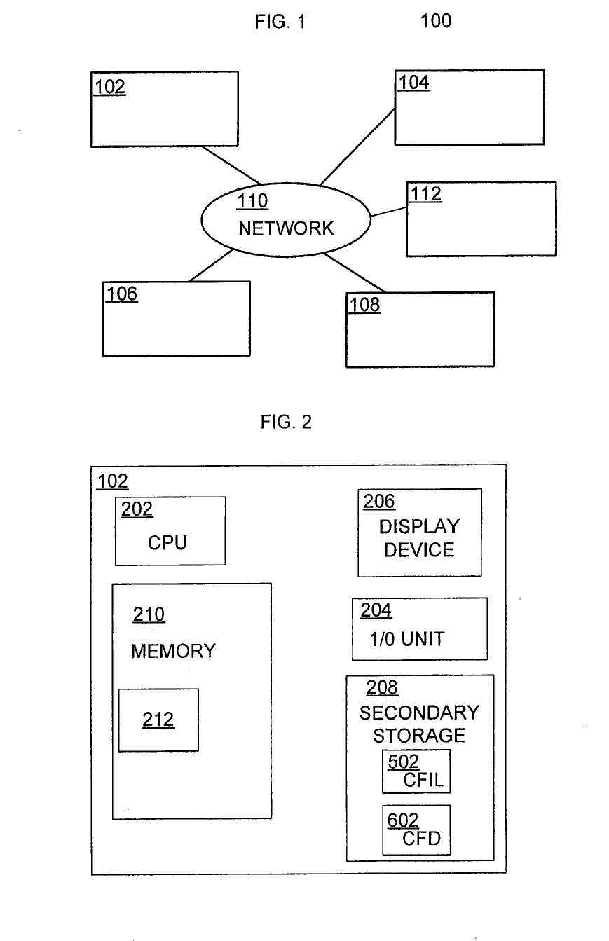

FIG. 1 depicts a block diagram of a system 100 suitable for practicing methods and implementing systems consistent with the present invention. System 100 comprises one or more data processing systems 102, 104, 106, and 108 that communicate over a network 110. The network can be, but is not limited to, a wide-area network, a local-area network, the Internet, a wireless network, and the like. As will be described in more detail below, a Searcher at one of the data processing systems, such as data processing system 102, may search for a Target that may reside on the Searcher's data processing system or another data processing system. System 100 may also include a query server 112.

FIG. 2 is a block diagram of data processing system 102 shown in more detail. One having skill in the art will appreciate that the other data processing systems and query server depicted in FIG. 1 may have a similar configuration to the one shown in FIG. 2. Data processing system 102 comprises a central processing unit (CPU) 202, an input output I/O unit 204, a display device 206, a secondary storage 208, and a memory 210. Data processing system 102 may further comprise standard input devices such as a keyboard, a mouse or a speech processing means (each not illustrated). Memory 210 contains a computer program 212 that manages Entities as described below.

The computer program, which is also referred to herein as the “program,” may comprise or may be included in one or more code sections containing instructions for performing their respective operations. The program is also referred to herein as the “Matching Engine.” While computer program 212 is described as being implemented as software, the present implementation may be implemented as any combination of hardware, firmware, and software or hardware or firmware alone. Also, one skilled in the art will appreciate that computer program 212 may comprise or may be included in a data processing device, which may be a server, communicating with data processing system 102.

Although aspects of one implementation are depicted as being stored in memory, one skilled in the art will appreciate that all or part of systems and methods consistent with the present invention may be stored on or read from other computer-readable media, such as secondary storage devices, like hard disks, floppy disks, tape cartridges, and CD-ROM; a carrier wave received from a network such as the Internet; or other forms of ROM or RAM either currently known or later developed. Further, although specific components of data processing system 102 have been described, one skilled in the art will appreciate that a data processing system suitable for use with methods, systems, and articles of manufacture consistent with the present invention may contain additional or different components.

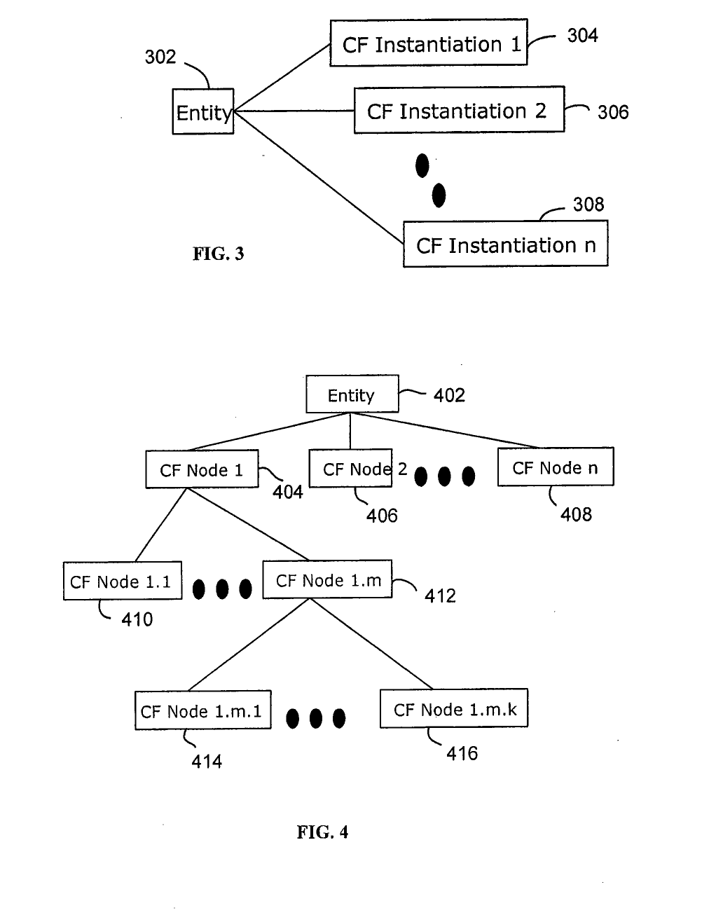

As shown in the illustrative example of FIG. 3, Entities may be classified by one or more CF Instantiations. Each CF Instantiation for an Entity may describe that Entity in a different way from each other CF Instantiation. In the example, Entity 302 is classified by CF Instantiations 304, 306, and 308.

In an illustrative example, Entity 302 represents a bicycle. CF Instantiation 304 may describe attributes of the bicycle relating to its physical attributes, method of manufacture, and ownership. CF Instantiation 306 may describe the bicycle's geographic location and relationships with other entities such as other vehicles owned by the owner. CF Instantiation 306 may describe maintenance manuals for the bicycle.

A CF Instantiation takes on a hierarchical form of organized CF Nodes and CF Arcs, where each CF Node may have a single CF Node that is its parent, and zero or more CF Nodes which are its children. This is shown in an illustrative example in FIG. 4. In the example, a CF Instantiation for an Entity (e.g., a bicycle) includes a top-level CF Node 402, which has children CF Nodes CF Node 1 404 (e.g. physical attributes), CF Node 2 406 (e.g., method of manufacture), through CF node n 408 (e.g., ownership). CF Node 1 has children CF Nodes CF Node 1.1 410 (e.g., color) through CF Node 1.m 412 (e.g., number of wheels). CF Node 1.m has children CF Nodes CF Node 1.m. 1 414 (e.g. type of rims) through CF Node 1.m.k 416 (e.g., type of tires). One having skill in the art will appreciate that the labels presented in this and other examples indicate an arbitrary numbering and/or naming scheme.

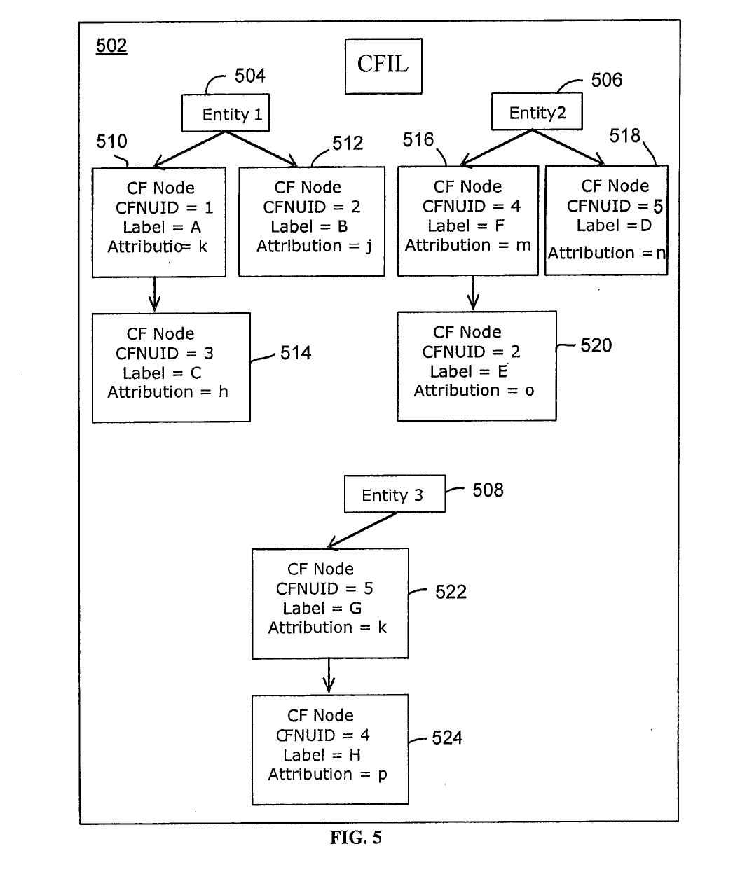

Each CF Node within a CF Instantiation may be identified by a CF Node Type, a CF Node Label, a CF Node Attribution, or additional or alternative identifiers. Referring to FIG. 5, an illustrative CF Instantiation Library (CFIL) 502 may include all known CF Instantiations. In the illustrative example, the CFIL is located in the data processing system secondary storage. However, one having skill in the art will appreciate that the CFIL, and other components described herein, may be located in other locations, such as on one or more distributed repositories in a loosely coupled network such as the Internet.

The illustrative CFIL includes CF Instantiations for several Entities, namely Entity 1 504, Entity 2 506, and Entity 3 508. Entity 1 (e.g., a bicycle) includes two child CF Nodes 510 and 512. Child CF Node 510 is associated with a CFNUID=1, CF Node Label=A (e.g., “Frame Type”), and CF Node Attribution=k (e.g., mountain bike). Child CF Node 512 is associated with a CFNUID=2, CF Node Label=B (e.g., “Color”), and CF Node Attribution=j (e.g., red). CF Node 510 in turn has a child CF Node 514, which is associated with a CFNUID=3, CF Node Label=C (e.g. “Frame Material”), and CF Node Attribution=h (e.g., titanium).

Entity 2 (e.g., a bicycle) has two child CF Nodes 516 and 518. Child CF Node 516 is associated with a CFNUID=4, CF Node Label=F (e.g., “Paint”), and CF Node Attribution=m (e.g., pre-painted). Child CF Node 518 is associated with a CFNUID=5, CF Node Label=D (e.g., “Assembled”), and CF Node Attribution=n (e.g., pre-assembled). CF Node 516 in turn has a child CF Node 520, which is associated with a CFNUID=2, CF Node Label=E (e.g., “Paint Color”), and CF Node Attribution=o (e.g., standard color).

Entity 3 (e.g., a wagon) has a single child CF Node 522, which is associated with a CFNUID=5, CF Node Label=G (e.g., “Assembly”), and CF Node Attribution=k (e.g., factory assembled). Child CF Node 522 in turn has a child CF Node 524, which is associated with a CFNUID=4, CF Node Label=H (e.g., “Paint Processing”), and CF Node Attribution=p (e.g., spray painted).

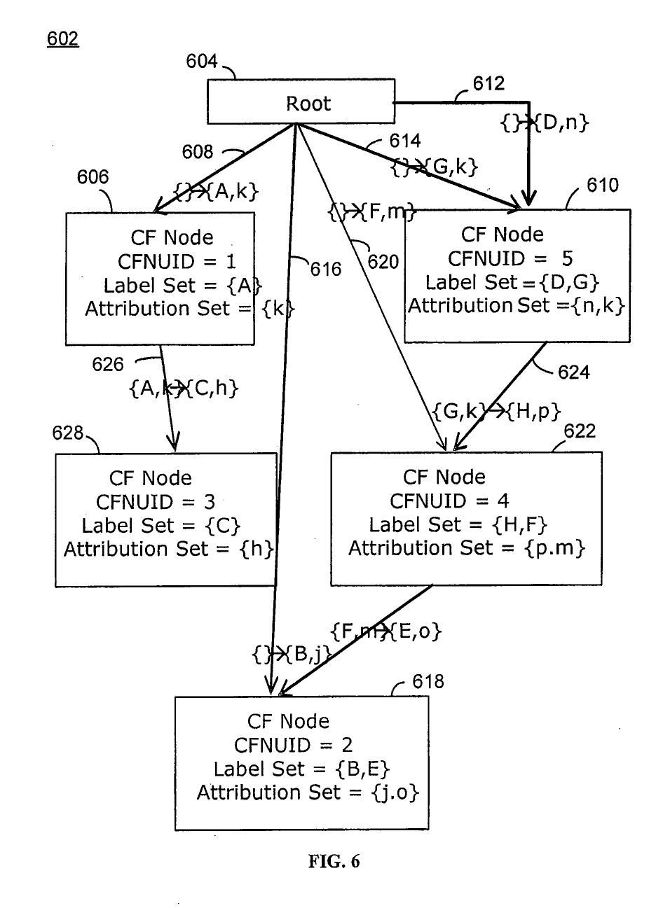

As will be described in more detail below, the computer program derives a CF Dictionary from the CFIL. The CF Dictionary is the set of unique CF Nodes as defined by their CFNUIDs. FIG. 6 depicts a block diagram of an illustrative CF Dictionary 602 corresponding to the CFIL of FIG. 5. The CF Arcs in the CF Dictionary are derived from the CF Arcs in the CFIL. Specifically, for each CF Arc in the CFIL between two CF Nodes with unique CFNUIDs, the computer program adds a corresponding CF Arc to the CF Dictionary between those same CF Nodes in the CF Dictionary. The CF Arc is labeled with the CF Labels and CF Attribution of the two CF Nodes in the CFIL. Therefore, it is possible that two CF Nodes in the CF Dictionary may have zero or more CF Arcs connecting them, and may generally be connected in multiple directions. A CF Node which has no parent is said to be connected to the “root.”

In the illustrative example, a root 604 (e.g. Entity 1, Entity 2, or Entity 3 in FIG. 5) is connected to CF Node 606 by CF Arc 608. Referring to FIG. 5, this association is derived in the CF Dictionary because there is a CF Arc between Entity 1 504 and the CF Node 510 defined by CFNUID “1.” CF Arc 608 is labeled {}->{A,k}. This represents that Entity 1 CF Node does not include a CF Label and CF Attribution (hence the empty set {}), and that CF Node 510 includes CF Label “A” and CF Attribution “k.” The CF Node 606 in the CF Dictionary identifies the set of respective CF Labels ({A} in this case) and the set of respective CF Attributions ({k} in this case).

Root 604 is also connected to CF Node 610 via CF Arcs 612 and 614. CF Arc 612 is labeled {}->{D,n} to represent that Entity 2 does not include a CF Label and CF Attribution (i.e., the empty set {}), and that CF Node 518 includes CF Label “D” and CF Attribution “n”. CF Arc 614 is labeled {}->{G,k} to represent that Entity 3 does not include a CF Label and CF Attribution (i.e., the empty set {}), and that CF Node 522 includes CF Label “G” and CF Attribution “k”. The resultant CF Node 610 for CFNUID=5 therefore includes a CF Label set={D,G} and a CF Attribution set={n,k}.

Additional relationships from the illustrative CFIL are derived in the CF Dictionary as follows: CF Arc 618 connects root 604 and CF Node 616, which is associated with CFNUID=2; CF Arc 622 connects root 604 and CF Node 620, which is associated with CFNUID=4; CF Arc 624 connects CF Node 610 and CF Node 622; and CF Arc 626 connects CF Node 606 and CF Node 628, which is associated with CFNUID=3.

Defining a CF

A user may request the program to define a CF for a Search or a Target. For example, the user may request to define a Searcher CF to match against existing Targets when conducting a search. Further, a user may request to define a CF for a Target to publish an available Entity with the classification defined by the CF. In either case, the party requesting to define the CF may be the beneficiary of work done by others in defining their CFs through the CF Dictionary. For example, the user may look at other CFs and request to include similar attributes.

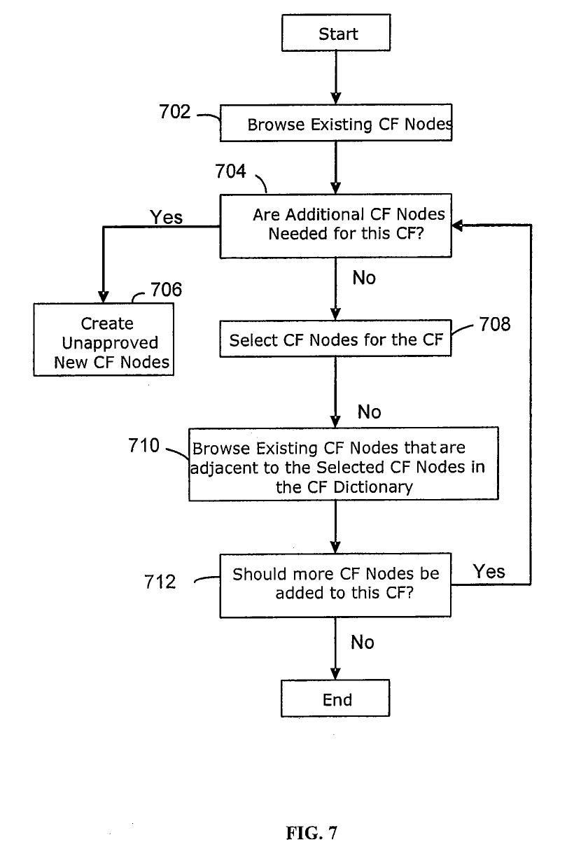

FIG. 7 is a flow diagram depicting illustrative steps performed by the computer program for defining a CF. First, the computer program browses the existing CF Dictionary for CF Nodes that are relevant to the CF being defined (step 702). If the computer program determines that the CF Node it requires is not part of the CF Dictionary (step 704), then it may add a CF Node to support its needs to the CF Dictionary (step 706). This added node is added in “unapproved” mode, which is discussed in more detail below. Then, the computer program selects a CF Node from the existing CF Nodes and their newly defined CF Nodes (step 708).

Upon this selection, the computer program browses the CF Dictionary for other CF Nodes that are “adjacent” to the selected nodes for modifying the CF (step 710). In this context, CF Nodes which are “adjacent” to a given CF Node means CF Nodes that are connected by a sequence of CF Nodes (excluding the “root”) and CF Arcs to the given node. For example, in the illustrative CF Dictionary of FIG. 6, the following pairs of nodes (identified by their CFNUIDs) are adjacent: {5,4}, {5,2}, {4,2}, and {1,3}, while the following pairs of nodes are not adjacent: {1,5}, {1,4}, {1,2}, {3,5}, {3,4},and {3,2}.

If the computer program determines that more CF Nodes should be added to the CF (step 712), then program flow returns to step 704.

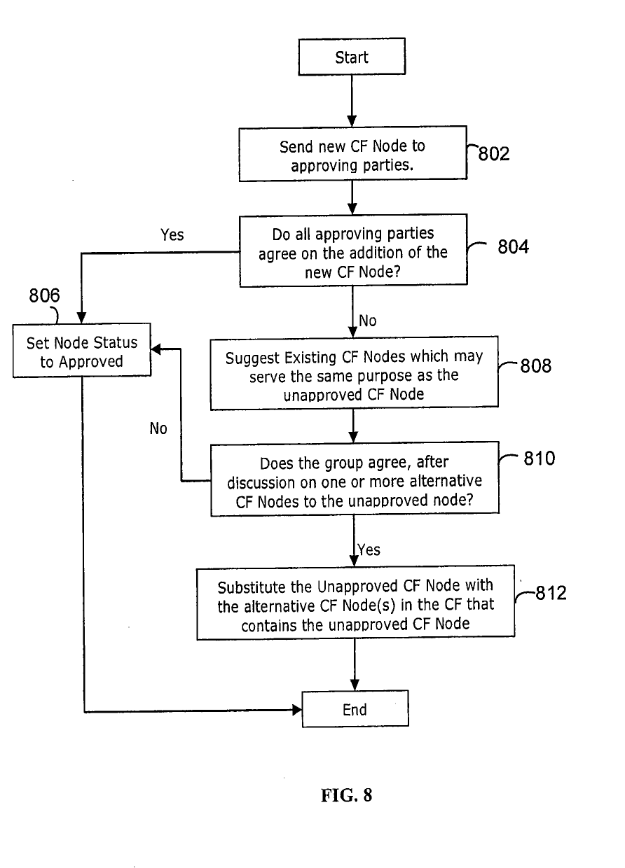

CF Nodes that are created in step 706 in an “unapproved” status undergo the approval process described with reference to FIG. 8. The program first sends the new CF Node to approving parties (step 802). The program does this, for example, by sending a message to the approving parties requesting whether the CF Node may be approved. The approving parties may be, for example, Searchers and Targets. After all or a predetermined number of approving parties respond, the computer program determines whether all of the approving parties agree on the addition of the new CF Node (step 804).

If the computer program determines in step 804 that the CF Node may be added, then the computer program sets the CF Node status to approved creates the new CF Node (step 806). If the CF Node is not approved, then the computer program suggests to the approving parties existing CF Nodes that may serve the same or a similar purpose as the unapproved CF Node (step 808). This may be done, for example, by sending messages to the approving parties and requesting their response. The alternative nodes may be chosen, for example, by analyzing nodes in the CF Dictionary to determine whether they have similar CF Labels or CF Attributions.

After the approving parties respond to the request, the program determines whether all approving parties agree to one or more of the suggested CF Nodes (step 810). If not, then the program approves the new CF Node that was originally decided on in step 804 (step 806). If the approving parties agree to one or more of the suggested CF Nodes in step 810, then the program substitutes the unapproved CF Node with the alternative CF Nodes (step 812). Program flow then proceeds back to step 708.

CF Comparison

CF Comparison is the mechanism by which the program matches Searchers and Targets. The program may analyze Target CFs to determine whether there similarities and complementaries to the Searcher CF. The match may be based upon similarities, as well as complementarities, or a combination of the two. For example, when searching for a web page, the Searcher can identify bicycles or web pages that have particular characteristics and that do not have other characteristics. The computer program may use a variety of approaches to perform the CF Comparison, such as Content Matching, Relationship Matching, Path Matching, or others.

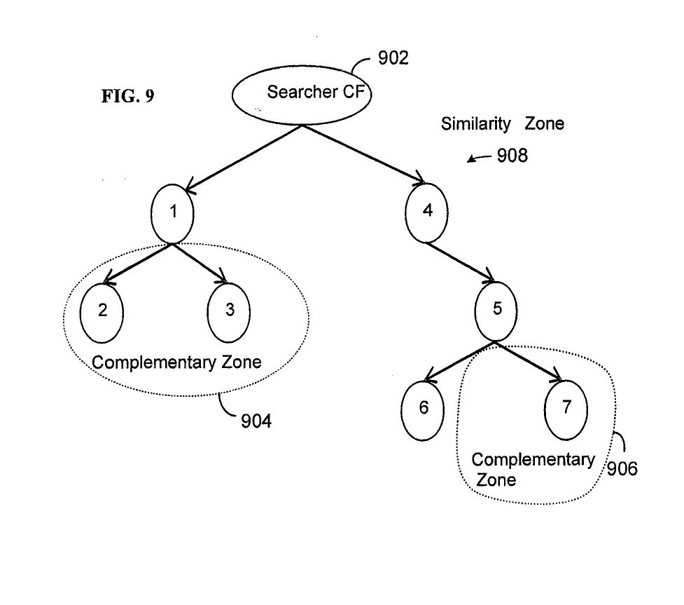

Prior to matching, the user may cause the program to mark (i.e., identify) sections of a Searcher CF as “similarity” or “complementary” matching zones. When the matching is performed, the program may then look for similar nodes or complementary nodes in the Target CF. FIG. 9 depicts an illustrative example of such a marking in a Searcher CF 902, where the circles represent CF Nodes and the numbers within the circles represent CFNUIDs. As shown, CF Nodes 2 and 3 are marked as being in a first Complementary Zone 904. CF Node 7 is marked as being in a second Complementary Zone 906. The remaining CF Nodes 1, 4, 5, and 6 are marked being in a Similarity Zone 908.

Content Matching is focused on the CF Nodes that are present in a CF Search Instantiation and CF Target Instantiations. The degree by which a CF Search Instantiation matches a CF Target Instantiation is increased for each CF Node they share in common in a Similarity Zone of the CF Search Instantiation, and decreased for each CF Node in the in Similarity Zone of the CF Search Instantiation but not in the CF Target Instantiation. Further, the degree to which a CF Search Instantiation matches a CF Target Instantiation is decreased by each CF Node that is present in the CF Target Instantiation and not present in the CF Search Instantiation Similarity Zone. The degree to which a CF Search Instantiation matches a CF Target Instantiation is increased for each CF node which is present in the Complementary Zone of the CF Search Instantiation and not present in the CF Target Instantiation, and decreased for each CF Node that is present in both the Complementary Zone of the CF Search Instantiation and the CF Target Instantiation. The magnitude of the increase or decrease in the degree by which the CF Search Instantiation and the CF Target Instantiation may be related by a general mathematical expression, including, but not limited to, cardinality, statistical, and other types of functions.

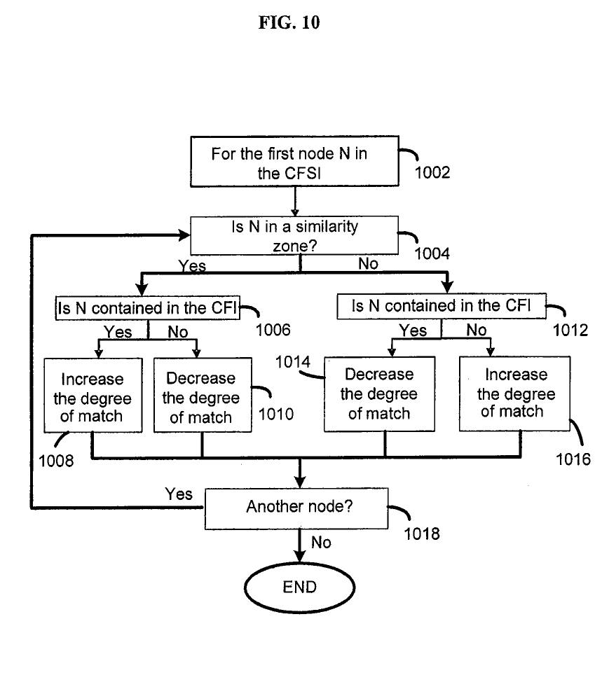

FIG. 10 is a flow diagram depicting illustrative steps performed by the program to perform Content Matching. The program first identifies the first CF Node in the CF Source Instantiation (step 1002). Then, the program determines whether the node is in a Similarity Zone (step 1004). If so, it is determined whether the node is contained in the CF Instantiation (step 1006). If the node is contained in the CF Instantiation, then the program increases the degree of match (step 1008). Otherwise, the program decreases the degree of match (step 1010).

If the program determines in step 1004 that the node is not in a Similarity Zone, then the program determines whether the node is contained in the CF Instantiation (step 1012). If the node is contained in the CF Instantiation, then the program decreases the degree of match (step 1014). Otherwise, the program increases the degree of match (step 1016).

If there is another node to analyze (step 1018), then the program flow returns to step 1004.

Relationship Matching considers not only Content Matching based comparison of CF Nodes, but also comparison of CF Arcs between the nodes. In addition to the rules for increasing or decreasing the degree of match described above, the following illustrative rules may apply in Relationship Matching. The degree to which a CF Search Instantiation matches a CF Target Instantiation is increased for each pair of nodes connected by a CF Arc as parent and child in the Similarity Zone of the CF Search Instantiation which are also present as parent and child connected by a CF Arc in the CF Target Instantiation. The degree to which a CF Search Instantiation matches a CF Target Instantiation is decreased for each pair of CF Nodes, A and B, where A is in the Similarity Zone and B is in the Complementary Zone of the CF Search Instantiation, A and B are connected by CF Arc in the CF Search Instantiation, and A and B are also present and connected by a CF Arc in the CF Target Instantiation. As with Content Matching, the magnitude of the increase or decrease in the degree by which the CF Search Instantiation and the CF Target Instantiation may be related by a general mathematical expression, including, but not limited to, cardinality, statistical, and other types of functions.

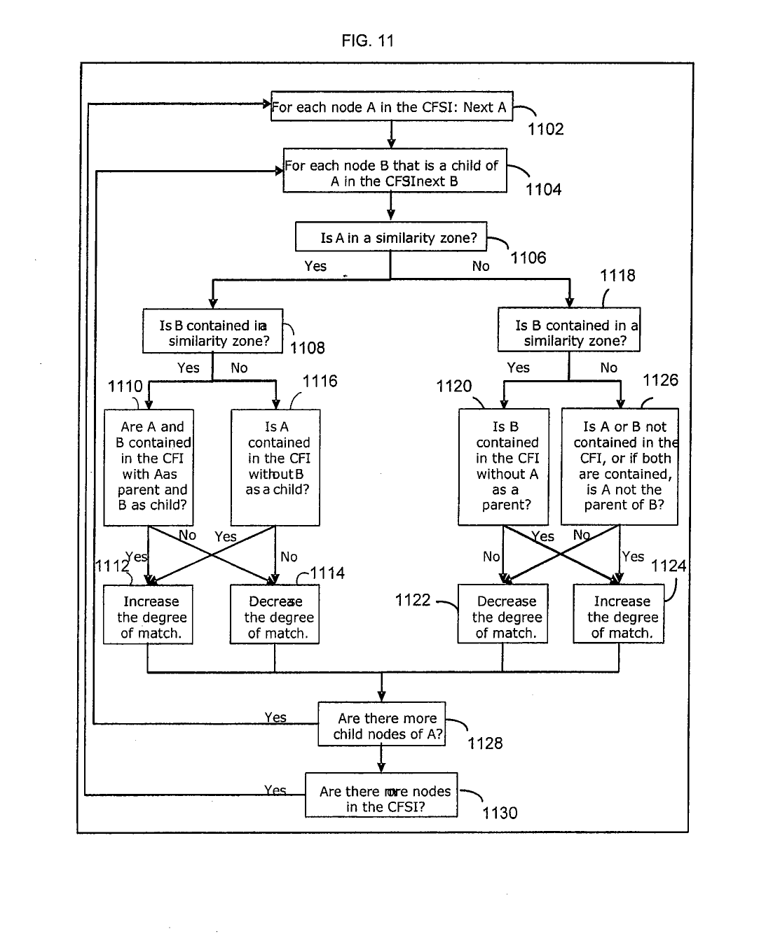

FIG. 11 is a flow diagram depicting illustrative steps performed by the program to perform Relationship Matching on a CF Search Instantiation and a CF Instantiation. First, the program identifies the next CF Node A in the CF Search Instantiation (step 1102). For each CF Node B that is a child of CF Node A (step 1104), the program determines whether CF Node A is in a Similarity Zone (step 1106).

If CF Node A is in a Similarity Zone, the program determines whether the CF Node B is contained in a Similarity Zone (step 1108). If so, then the program determines whether CF Nodes A and B are contained in the CF Instantiation with A as parent and B as child (step 1110). If so, the program increases the degree of match (step 1112). Otherwise, the program decreases the degree of match (step 1114). If it is determined that the CF Node B is not contained in the Similarity Zone in step 1108, then the program determines whether A is contained in the CF Instantiation without B as a child (step 1116). If so, the program increases the degree of match (step 1112). Otherwise, the program decreases the degree of match (step 1114).

If CF Node A is not in a Similarity Zone as determined in step 1106, the program determines whether the CF Node B is contained in a Similarity Zone (step 1118). If so, the program determines whether CF Node B is contained in the CF Instantiation without A as parent (step 1120). If so, the program increases the degree of match (step 1124). Otherwise, the program decreases the degree of match (step 1122). If it is determined that the CF Node B is not contained in the Similarity Zone in step 1118, then the program determines whether A or B is not contained in the CF Instantiation, or if both are contained, whether A is not the parent of B (step 1126). If so, the program increases the degree of match (step 1124). Otherwise, the program decreases the degree of match (step 1122).

If there are more child nodes of A, then the program flow returns to step 1104 (step 1128). Otherwise, if there are more nodes in the CF Search Instantiation, then program flow returns to step 1102 (step 1130).

Path Matching considers the CF Paths between nodes as well as Content and Relationship Matching. In addition to the illustrative rules for increasing or decreasing the degree of match described above, the following illustrative rules may apply in Path Matching. The degree to which a CF Search Instantiation matches a CF Target Instantiation is increased for each pair of nodes connected by a CF Path in the Similarity Zone of the CF Search Instantiation which are also present as parent and child connected by a CF Path in the CF Target Instantiation. The degree to which a CF Search Instantiation matches a CF Target Instantiation is decreased for each pair of CF Nodes, A and B, where A is in the Similarity Zone and B is in the Complementary Zone of the CF Search Instantiation, A and B are connected by CF Path in the CF Search Instantiation, and A and B are also present and connected by a CF Path in the CF Target Instantiation. The magnitude of the increase or decrease in the degree by which the CF Search Instantiation and the CF Target Instantiation may be related by a general mathematical expression, including, but not limited to, cardinality, whether the path in the CF Search Instantiation or CF Target Instantiation are CF Directed Paths, the commonalities or differences in the CF Nodes and CF Arcs contained in the two CF Paths, statistical, and other types of functions.

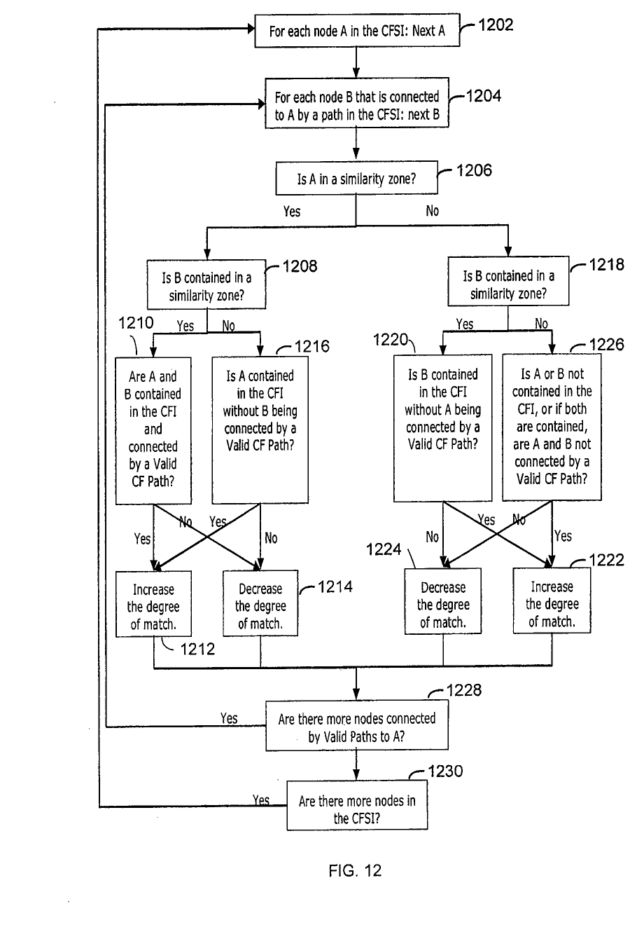

A CF Path may be ignored in Path Matching if a CF Path Constraint is applied to the CF Instantiations and this CF Path is not a Valid CF Path with respect to the CF Path Constraint. When no CF Path Constraint is used in Path Matching, all CF Paths are Valid CF Paths for matching. FIG. 12 is a flow diagram depicting illustrative steps performed by the program for Path Matching.

As shown in FIG. 12, the program first obtains the next CF Node A in the CF Search Instantiation (step 1202). For each CF Node B that is connected to CF Node A by a path (step 1204), the program determines whether CF Node A is in a Similarity Zone (step 1206).

If CF Node A is in a Similarity Zone, the program determines whether the CF Node B is contained in a Similarity Zone (step 1208). If so, then the program determines whether CF Nodes A and B are contained in the CF Instantiation and connected by a Valid CF Path (step 1210). If so, the program increases the degree of match (step 1212). Otherwise, the program decreases the degree of match (step 1214). If it is determined that the CF Node B is not contained in the Similarity Zone in step 1208, then the program determines whether A is contained in the CF Instantiation without B being connected by a Valid CF Path (step 1216). If so, the program increases the degree of match (step 1212). Otherwise, the program decreases the degree of match (step 1214).

If CF Node A is not in a Similarity Zone as determined in step 1206, the program determines whether the CF Node B is contained in a Similarity Zone (step 1218). If so, the program determines whether CF Node B is contained in the CF Instantiation without A being connected by a Valid CF Path (step 1220). If so, the program increases the degree of match (step 1222). Otherwise, the program decreases the degree of match (step 1224). If it is determined that the CF Node B is not contained in the Similarity Zone in step 1218, then the program determines whether A or B is not contained in the CF Instantiation, or if both are contained, whether A and B are not connected by a Valid CF Path (step 1226). If so, the program increases the degree of match (step 1222). Otherwise, the program decreases the degree of match (step 1222).

If there are more nodes connected by Valid Paths to A, then the program flow returns to step 1204 (step 1228). Otherwise, if there are more nodes in the CF Search Instantiation, then program flow returns to step 1202 (step 1230).

In an embodiment, the matching process may be distributed across multiple data processing system. For example, the program may submit at least a part of the CF Search Instantiation information to the query server 112. In turn, the query server may delegate parts of the query to one or more of the data processing systems 102, 104, 106, 108. The other data processing systems perform a matching process, using local or remote CFILs, and return the results back to the query server, which aggregates the results and sends them back to the program.

CF Modification

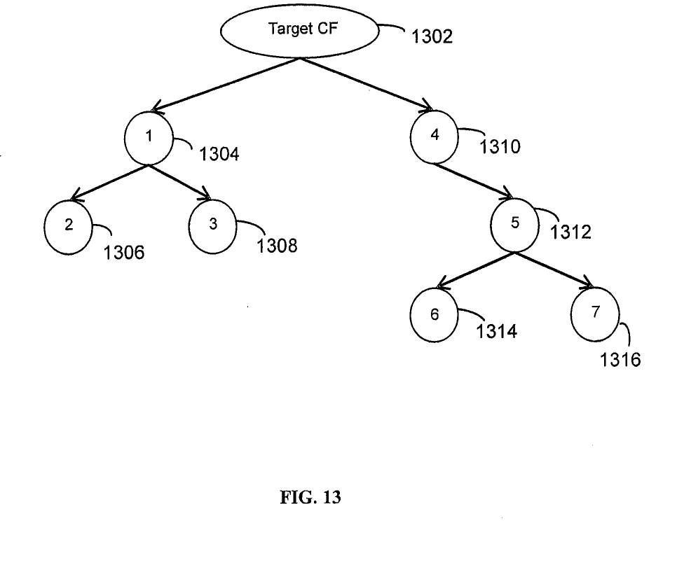

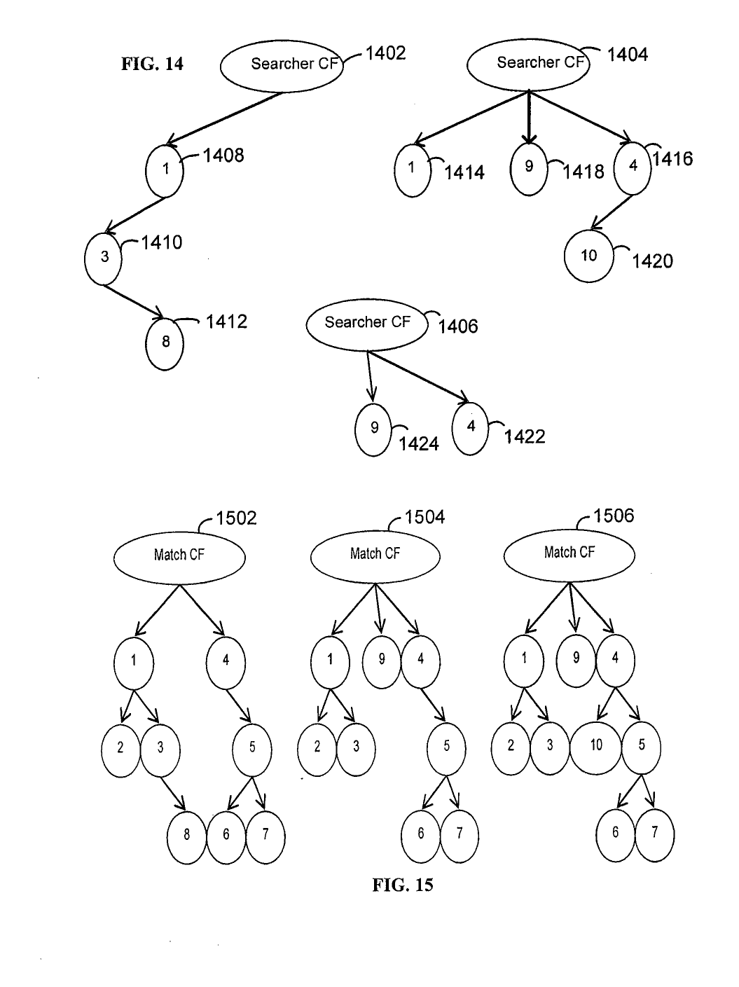

Each time the action of a Searcher causes the program to compare two CF Instantiations, information about the comparison can be used to provide guidance. For example, the illustrative Target CF Instantiation 1302 of FIG. 13 is compared to the three Searcher CF Instantiations 1402, 1404, and 1406 of FIG. 14. Target CF Instantiation 1302 includes CF Nodes 1304, 1306, 1308, 1310, 1312, 1314, and 1316. Searcher CF Instantiation 1402 includes CF Nodes 1408, 1410, and 1412. Searcher CF Instantiation 1404 includes CF Nodes 1414, 1416, 1418, and 1420. Searcher CF Instantiation 1406 includes CF Nodes 1422 and 1424.

The program compares the Target CF Instantiation to the three Searcher CF Instantiations and yields the CF Match Library shown in FIG. 15. In the illustrative example, the resultant CF Instantiations in the CF Match Library include a union of CF Nodes and CF Arcs of the two CF Instantiations having been compared. For example, the program combines Target CF Instantiation 1302 with Searcher CF Instantiation 1402 to yield CF Instantiation 1502, combines Target CF Instantiation 1302 with Searcher CF Instantiation 1404 to yield CF Instantiation 1506, and combines Target CF Instantiation 1302 with Searcher CF Instantiation 1406 to yield CF Instantiation 1504. As shown, the illustrative resultants CF Instantiations are a union of the two compared CF Instantiations.

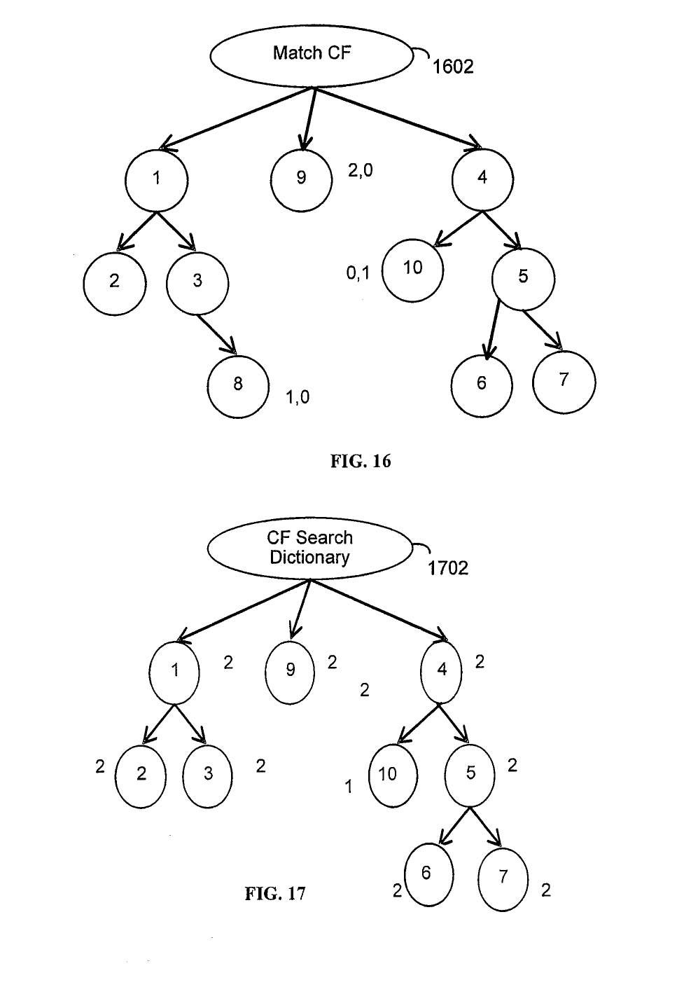

The program may use items in the CF Match Library, for example, for further searches or combinations. Further, a CF Match Dictionary 1602 may be created as shown in the illustrative example in FIG. 16, where the numbers next to CF Nodes 8, 9, and 10 indicate the relative number of times they appeared in Searcher CF Instantiations but were not contained in the Target CF Instantiations. In an embodiment, the numbers may appear in pairs indicating the number of times they appeared in a Similarity versus Complementary context.

When creating a Target CF, the program may utilize the CF Match Library and CF Match Dictionary to include items in the Target CF that may otherwise have been overlooked. For example, the program may include attributes that have appeared in the Search CFs of prior searches. Such information may be used for, but not limited to, improving a Target's ability to be found, improving the items being described by the Target CF for better community acceptance (for example, product improvement, or new product development in a corporation), and so forth. The program may also look to the CF Match Library and CF Match Dictionary when modifying a Searcher's CF to improve its effectiveness.

The program may also modify CFs based on additional criteria, such as inputted user preferences. In the illustrative example discussed above with reference to FIGS. 13-15, a searcher may observe that Searcher CF Instantiation 1406 has been matched with CF Instantiations 1504 and 1506. These Target CF Instantiations may be combined by the program into the illustrative CF Search Dictionary 1702 as shown in FIG. 17.

The numbers next to each CF Node indicate the number of Target CF Instantiations in which those nodes were included in the results of matching the Search CF Instantiation against Target CF Instantiations. This information may be presented by the program to a user to allow the user to provide desired modifications to a CF Instantiation. For example a Searcher may select or deselect CF Nodes in a Searcher CF Instantiation to improve search results. The program may present the information in a variety of manners, such as relief maps, bar charts, pie charts, and so forth, including the CF Nodes and their significance in relation to the Search CF Instantiation. The visualization mechanism may be equipped with interaction that allows the user to select and deselect items in their Search CF Instantiation, redefining it in conjunction with its visualization. For example, the Searcher may see that CF Node 1 is a commonly occurring theme, and select CF Node 1. Further, the Searcher may choose to deselect CF Node 9 from the Searcher CF Instantiation.

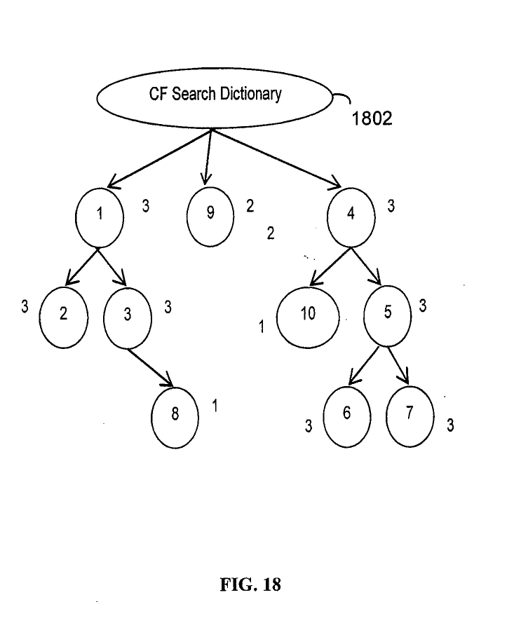

In the illustrative example, the result of user input may be that the Search CF Instantiation 1406 of FIG. 14 now matches Target CF Instantiations 1502, 1504, and 1506 of FIG. 15, instead of only Target CF Instantiations 1504 and 1506. The resulting CF Search Dictionary 1802 is shown in FIG. 18.

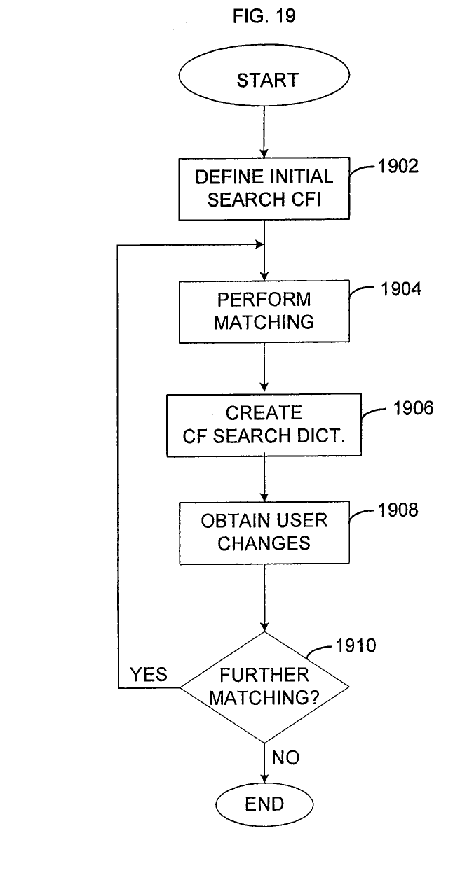

FIG. 19 is a flow diagram depicting illustrative steps performed by the program for modifying a CF responsive to user input as discussed above. Initially, the program defines the initial Search CF Instantiation (step 1902). Then, the program performs matching of the Search CF Instantiation with CF Instantiations in the CF Instantiation Library (CFIL) (step 1904). For all CF Instantiations in the CFIL determined to match (Matches) the Search CF Instantiation, the program constructs the CF Search Dictionary by creating a CF Instantiation that represents the union of CF Nodes and CF Arcs in the Matches, and the relative count for each CF Node and CF Arc in the CF Search Dictionary of the number of CF Instantiations in the Matches that contained that CF Node or CF Arc (step 1906).

Then, the program presents the CF Search Dictionary to the user through a visualization mechanism, such as on the display device (step 1908). The user inputs requests, for example, to add or delete CF Nodes from the Search CF Instantiation (step 1910). This may be done, for example, by presenting the information relating to one or more of the CF Nodes on the display device and allowing the user to select or deselect nodes. The program receives the user input and modifies the relevant CF Nodes and CF Arcs in the Search CF Instantiation. If the user desires an additional search based on the modified CF Instantiation, then program flow returns to step 1904.

CF Transformation

The CF Path based matching described above allows CF Instantiations that may have similarities but that may not exactly coincide in structure to a match regardless of these differences. A CF Transformation Lens provides a mechanism through which CF Instantiations of varying structure may be translated and viewed through a common structure.

A CF Transformation Lens may include the following illustrative items:

One or more CF Instantiations (CF Transformation Instantiations).

A set of criteria associated with each CF Node (CF Transformation Node) in each of the CF Transformation Instantiations that determines whether other CF Instantiations may be transformed into the CF Transformation Instantiation. Such criteria may include the following illustrative items:
A list of CF Nodes connected by a Boolean expression which, if present in a CF Instantiation in a manner that satisfies the Boolean expression, will indicate that the CF Transformation Node is present in the CF Transformation Instantiation.
A list of CF Node Paths and CF Node Directed Paths connected by a Boolean expression which, if present in a CF Instantiation in a manner that satisfies the Boolean expression, will indicate that the CF Transformation Node is present in the CF Transformation Instantiation.

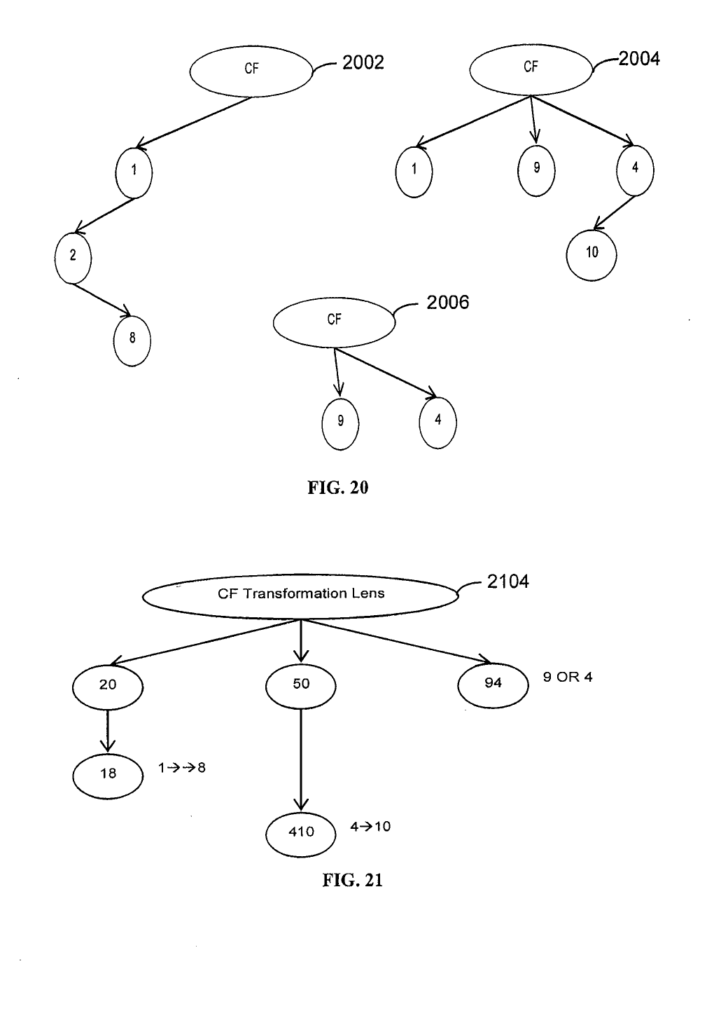

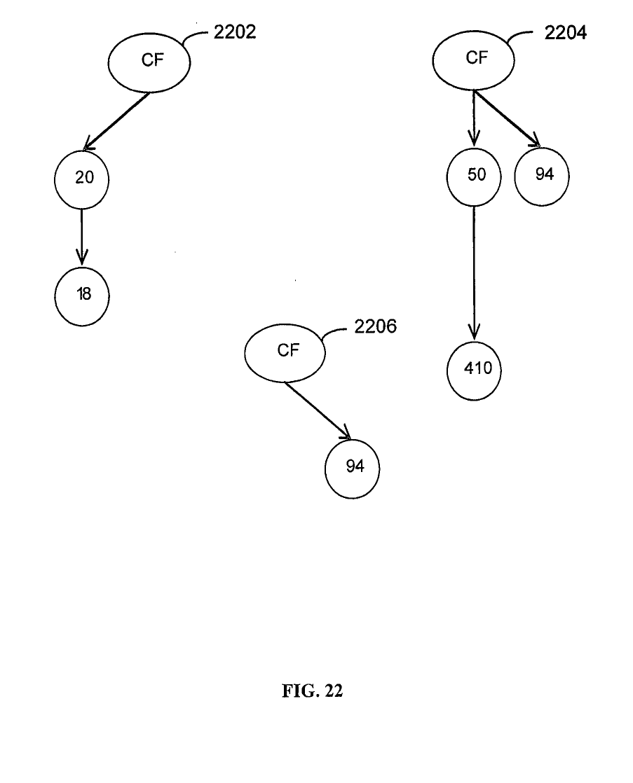

FIG. 20 depicts illustrative CF Instantiations 2002, 2004, and 2006. These may be viewed through a CF Transformation Lens, such as the illustrative CF Transformation Lens 2104 of FIG. 21. In FIG. 21, the labels next to each CF Node indicate the criteria for that node. The resultant CF Instantiations 2202, 2204, and 2206 are shown in FIG. 22. The following illustrative criteria notation are used: 1) A→→B means a directed path from CF Node A to CF Node B, 2) A→B means a CF Arc from A to B, and 3) A OR B means the presence of either node A or B.

Each CF Instantiation that results from the transformation may include all nodes in the CF Transformation Instantiation for which the criteria are satisfied when compared against the original CF Instantiation prior to its transformation. The transformation of CF Instantiations may or may not create new CF Instantiations. Such transformed CF Instantiations may exist virtually. For example, the Matching Engine or Navigation components described above may utilize transformations during the matching or navigation process but not actually save the CF Instantiations created by the transformations.

Integration with Conventional Matching Methods

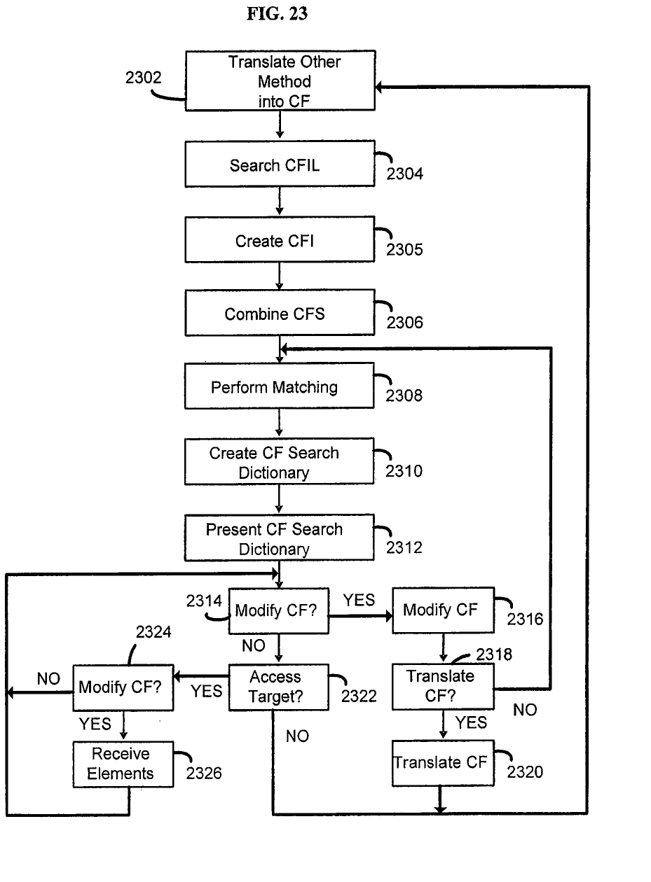

CF Matching approaches consistent with the present invention may be implemented in conjunction with conventional matching methods to provide CF Classifications for those Targets. For purposes of example only, a standard keyword based search may be considered a conventional method. When used in conjunction with a conventional method, CF matching, navigation, and visualization tools consistent with the present invention may appear to the Searcher simultaneously with the conventional method, and the Searchers will interact with the two methods as described below with reference to FIG. 23.

The Searcher may utilize a conventional method to generate a set of Targets. For example, the Searcher may use a keyword-based search to generate a set of Targets. The program obtains the Searcher's method for searching with the conventional method and translates it into a CF Instantiation, i.e. a Translated CF Instantiation (step 2302). This may be done, for example, by receiving user input that identifies the parameters used for the conventional method, such as the keywords used for a keyword search.

Then, the program searches the existing CF Instantiation Library for CF Instantiations that may already be associated with one or more of the located Targets (step 2304). When the located targets are not referenced in the CF Instantiation Library, new CF Instantiations may be created for those targets and added to the CF Instantiation Library by the program which accesses those targets over the network (step 2305). The CF Instantiations may be flat, based on words, images, or other information contained in the target, or may be hierarchical CF Instantiations created by passing those words, images, or other information through one or more CF Transformation Lenses. The program creates a union of the Translated CF Instantiation and the CF Instantiations of the located Targets to form a new Search CF Instantiation (step 2306).

The program then performs a matching of the Search CF Instantiation with CF Instantiations in the CF Instantiation Library (CFIL), including CF Instantiation that were created in step 2305 (step 2308). For CF Instantiations in the CFIL determined to match (Matches) the Search CF Instantiation (with the matching as defined by a threshold on the degree of match), the program constructs the CF Search Dictionary by creating a CF Instantiation that represents the union of CF Nodes and CF Arcs in the Matches (step 2310). The CF Search Dictionary includes the relative count for each CF Node and CF Arc of the number of CF Instantiations in the Matches that contained that CF Node or CF Arc.

The CF Search Dictionary is then displayed to the Searcher through a visualization mechanism, such as on the display device (step 2312). As discussed above, the CF Search Dictionary may be displayed in one or more of a variety of formats, such as, as a graph or tree that identifies the various nodes.

After reviewing the CF Search Dictionary, the user may want to modify the Search CF Instantiation, for example by adding or deleting CF Nodes or CF Arcs. If the program receives input from the user to modify the Search CF Instantiation (step 2314), then the program implements the desired modifications (step 2316). Modifying Search CF Instantiations is described above. The modified Search CF Instantiation may be used to perform a further matching by the program by returning to step 2308, or the user may select to convert the modified Search CF Instantiation into a query suitable for use by the conventional method (step 2318). If the user wants to translate the Search CF Instantiation into a query suitable for the conventional method, then the program may do so (step 2320). For example, the Search CF Instantiation may be converted into a keyword search by assigning CF Node Attributions to keywords.

If the user does not want to modify the Search CF Instantiation in step 2314, then the program determines whether the user wants to access one of the Targets (step 2322). This may be done, for example, by receiving a user inputted click on a hyperlink that takes the Searcher to a Target web page. After accessing the Target, program flow may return to step 2314 to allow the Searcher to modify the Search CF Instantiation, or the Searcher may first select elements of the accessed Target for addition or deletion from the Search CF Instantiation (step 2324). The program receives the selected elements of the accessed Target and then returns to step 2314 to modify the Search CF Instantiation (step 2326).

Proactive Notification

A user, such as a Searcher, may at any time during a search ask the program to save their Search CF Instantiation for later use. The program may register Search CF Instantiations with a CF Matching engine such that through the course of matching, the results that may have been generated can be communicated to the original Searcher who created the Search CF Instantiation.

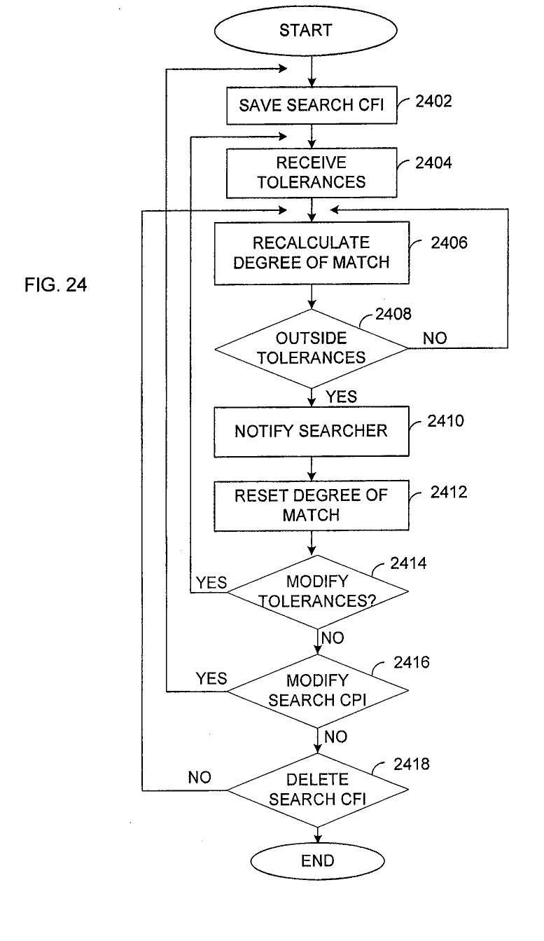

FIG. 24 is a flow diagram depicting illustrative steps performed by the program for communicating the results to a Searcher. At any time during a Search process as described above, the Searcher may indicate to save their Search CF Instantiation and make it available to a Matching Engine for future use (step 2402). The Searcher will indicate to the Matching Engine a set of tolerances that may be described in whole or by subsets of CF Nodes or CF Arcs such that when the results returned by matching the Saved Search CF Instantiation differ outside of the bounds of those tolerances from the original results, the Searcher who saved the Search CF Instantiation may be notified of the exceeding of their tolerance (step 2404). By way of example and not limitation, tolerances may be described in terms of CF Node or CF Arc counts, percentages, or other statistical metrics. Also by way of example and not limitation, notification may be delivered by means such as e-mail, telephone, pager, or other means.

With subsequent uses of the Matching Engine or upon subsequent updates of Target CF Instantiations, the program recalculates the degree of match generated by the Search CF Instantiation (step 2406). If the program determines that the degree of match lies outside the bounds of the tolerances (step 2408), then the Searcher is notified (step 2410). Then, the program resets the degree of match against which tolerances are compared to the current degree of match (step 2412).

The Searcher may access their Search CF Instantiation upon notification. If the Searcher wants to modify their tolerances (step 2414), then program flow returns to step 2404. If the Searcher wants to modify the Search CF Instantiation, then program flow returns to step 2402. If the Searcher wants to delete the Search CF Instantiation (step 2418), then program flow returns to step 2406.

Sharing CF Instantiations

As described above, the CF Instantiation Library may reside on distributed devices. For example, such devices may be data processing systems 102, 104, 106, and 108 connected to the network, which may be for example the Internet. Each such installment of the CFIL may have its own security policy set by the owners of that installment. By way of example and not limitation, the following restrictions may be put in place:
1) No members of the CFIL are visible outside of their local installment.
2) Specific CF Instantiations may be made public in their entirety.
3) Components of specific CF Instantiations may be made public by CF Node, CF Arc, or all CF Node Descendants from a given CF Node.
4) Access may be controlled on a CF Node or CF Arc basis across the entire CFIL by setting permissions similar to the above on nodes within the CF Dictionary.
5) The Targets to which any given CF Instantiation is linked may be made public or kept private.

The program or a separate component, such as a component residing in memory on the query server, may act as a CF Access Controller to function as a multi-way communication agent between CF Matching Engines, the CFIL, and the Searchers and Targets represented by the CF Instantiations in the CFIL. For example, the program may provide the following illustrative functionality:
1) Receive requests for CF Instantiations for matching purposes from other CF Matching Engines.
2) Disseminate public portions of the CF Instantiations in the CFIL to another Matching Engine for matching.
3) Track a Searcher's access of the information in the installment of the CFIL in terms of number of results used, number of results attempted for access, and so forth.
4) Notify the Target or Searcher, or automated software agent (Owner) in representation thereof, associated with accessed CF Instantiations, allowing such Owner to grant permission for access to non-public components of the accessed CF Instantiations. Such granting of permission may involve, but not be limited to, a required exchange of information, monetary instrument, and so forth.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software but the present implementation may be implemented as a combination of hardware and software or hardware alone. The invention may be implemented with both object-oriented and non-object-oriented programming systems. The scope of the invention is defined by the claims and their equivalents.

What is claimed is:

1. A data processing system configured and programmed to execute a method for locating an item, the method comprising the steps of:
obtaining at least one search parameter for locating the item;
classifying the at least one search parameter into a search classification; and
comparing the search classification to at least one target search classification associated with a target item and determine whether the target item matches or loosely matches the item,
wherein,
each of the search classification and the target search classification comprises a framework of one or more nodes,
each node of the framework comprises a characteristic of an item described by the classification.

2. The data processing system of claim 1, further comprising the step of:
outputting information relating to a result of the comparison.

3. The data processing system of claim 1, wherein the search classification includes a search hierarchy having at least one search node, each search node having zero or more search-node arcs connecting a search node to another search node, each search node representing a characteristic of the item, and
wherein the target search classification includes a target hierarchy having at least one target node, each target node having zero or more target-node arcs connecting a target node to another target node, each target node representing a characteristic of the target.

4. The data processing system of claim 3, wherein the comparison step includes comparing at least one of the search classification search nodes to at least one of the target search classification target nodes.

5. The data processing system of claim 4, wherein the comparison step includes determining whether at least one of the search classification search nodes is similar to at least one of the target search classification target nodes.

6. The data processing system of claim 4, wherein the comparison step includes determining whether at least one of the search classification search nodes is complementary to at least one of the target search classification target nodes.

7. The data processing system of claim 1, further comprising the step of:
modifying at least one of the search classification and the target classification to increase the chance of a match or loose match.

8. The data processing system of claim 7, further comprising the steps of:
displaying a visualization of at least one of the search classification and the target classification; and
receiving a user input identifying a modification to at least one of the search classification and the target classification.

9. The data processing system of claim 1, wherein the obtained at least one search parameter may be used with an alternative method for locating the item, and the method further comprises the step of:
translating the obtained at least one search parameter into a format different than its original format.

10. The data processing system of claim 1, wherein the at least one target classification is distributed over a plurality of data processing systems, and the comparing step comprises comparing the search classification to the at least one target classification on the plurality of data processing systems.

11. A tangible computer-readable medium having instructions that cause a data processing system to perform a method for locating an item, the method comprising the steps of:
obtaining at least one search parameter for locating the item;
classifying the at least one search parameter into a search classification; and
comparing the search classification to at least one target search classification associated with a target item to determine whether the target item matches or loosely matches the item,
wherein,
each of the search classification and the target search classification comprises a framework of one or more nodes,
each node of the framework comprises a characteristic of an item described by the classification.

12. The tangible computer-readable medium of claim 11, further comprising the step of:
outputting information relating to a result of the comparison.

13. The tangible computer-readable medium of claim 11, wherein the search classification includes a search hierarchy having at least one search node, each search node having zero or more search-node arcs connecting a search node to another search node, each search node representing a characteristic of the item, and
wherein the target search classification includes a target hierarchy having at least one target node, each target node having zero or more target-node arcs h connecting a target node to another target node, each target node representing a characteristic of the target.

14. The tangible computer-readable medium of claim 13, wherein the comparison step includes comparing at least one of the search classification search nodes to at least one of the target search classification target nodes.

15. The tangible computer-readable medium of claim 14, wherein the comparison step includes determining whether at least one of the search classification search nodes is similar to at least one of the target search classification target nodes.

16. The tangible computer-readable medium of claim 14, wherein the comparison step includes determining whether at least one of the search classification search nodes is complementary to at least one of the target search classification target nodes.

17. The tangible computer-readable medium of claim 11, further comprising the step of:
modifying at least one of the search classification and the target classification to increase the chance of a match or loose match.

18. The tangible computer-readable medium of claim 17, further comprising the steps of:
displaying a visualization of at least one of the search classification and the target classification; and
receiving a user input identifying a modification to at least one of the search classification and the target classification.

19. The tangible computer-readable medium of claim 11, wherein the at least one search parameter may be used with an alternative method for locating the item, and the method further comprises the step of:
translating the obtained at least one search parameter into a format different than its original format.

20. The tangible computer-readable medium of claim 11, wherein the at least one target classification is distributed over a plurality of data processing systems, and the comparing step comprises comparing the search classification to the at least one target classification on the plurality of data processing systems.

21. A data processing system comprising:
a memory in which is stored a computer program for locating an item that obtains at least one search parameter for locating the item, classifies the at least one search parameter into a search classification, and compares the search classification to at least one target search classification associated with a target item to determine whether the target item matches or loosely matches the item; and
a processing unit that runs the computer program,
wherein,
each of the search classification and the target search classification comprises a framework of one or more nodes,
each node of the framework comprises a characteristic of an item described by the classification.

22. A data processing system configured to run executable code, the data processing system when executing said code including:
means for obtaining at least one search parameter for locating the item;
means for classifying the at least one search parameter into a search classification; and
means for comparing the search classification to at least one target search classification associated with a target item to determine whether the target item matches or loosely matches the item,
wherein,
each of the search classification and the target search classification comprises a framework of one or more nodes,
each node of the framework comprises a characteristic of an item described by the classification.

23. The data processing system of claim 1, wherein two or more nodes of at least one of the search classification and the target search classification are connected by means of arcs.

24. The tangible computer-readable medium of claim 11, wherein two or more nodes of at least one of the search classification and the target search classification are connected by means of arcs.

25. The data processing system of claim 21, wherein two or more nodes of at least one of the search classification and the target search classification are connected by means of arcs.

26. The data processing system of claim 22, wherein two or more nodes of at least one of the search classification and the target search classification are connected by means of arcs.
